(19) United States
(12) Patent Application Publication
(10) Pub. No.: US 2021/0133745 A1
(43) Pub. Date: May 6, 2021

(54) Determine an Estimation of Chargeback for Cloud Consumption by Enterprises

(71) Applicant: Prashant Shyamsundar Mishra, Redmond, WA (US)

(72) Inventor: Prashant Shyamsundar Mishra, Redmond, WA (US)

(21) Appl. No.: 16/675,272

(22) Filed: Nov. 6, 2019

(51) Int. Cl. G06Q 20/40; G06F 11/34; G06F 11/30

(52) U.S. Cl. CPC G06Q 20/407; G06F 11/3086; G06F 11/3442

(57) ABSTRACT

This invention determines the team wise cloud resources usage. Organization will select the required cloud services from different cloud providers. These cloud services will be used by different business units and cloud bill be generated by cloud providers. Cloud brain will generate the charge sheet for different business unit as per the usage of cloud resource usage and will send to administrative department of organization. Administrative department will distribute charge back report to different managers. Managers will analyze report and will take appropriate decision. This tool will help managers to use cloud resources efficiently.

### FIELD

This disclosure relates to the capability of any organization to track & measure the team wise cloud resources allocation, consumption & their respective expenses by different business teams for their use of respective cloud services and charge back them accordingly. Any small or large-scale enterprises can benefit from this team-based charge back module by computing used cloud services are metered like anything, so that user only pays for services which they use. Internally enterprises can charge back business teams to educate their business teams heads about the cloud resource usage and their respective expenditures efficiently. This charge back module has a default & variable set of rates for billing.

### BACKGROUND

Organizations across various businesses are using cloud technology for their applications, data and file storage to achieve reliability, scalability, security, productivity and cost effectiveness. Companies are having different business teams which are working on set of services, which ultimately cumulated to the overall expenditure of the company. With such regular strategies of companies, it is very complex to get the detailed information about different business teams in terms of their resource usage and their respective expenses.

Company which is working in cloud and their business teams which are utilizing those cloud services, if gets a random freedom in terms of resources allocation & usage in cloud, expenses will be much higher. To solve this problem now a days new terminology is introduced as a chargeback, which provides the ability to any organization for tracking & measuring their cloud consumption, expenses per business team's used cloud services and charge them back accordingly, ultimately makes respective heads from different business teams more accountable for cloud service's usage and expenses.

This estimation of chargeback for cloud consumption by enterprises module is composed of an algorithm which has different business teams as per company working profile, their allocated cloud services, used services, charge sheets as per group of services used by different business teams, assignment to different business team's manager, report generation & decision making.

In the estimation of chargeback for cloud consumption by enterprise module provides the billing of different business team's cloud services usage. Company can have different business teams like accounting, engineering, marketing, purchasing, R & D sections, retail operations, services, support & many more. These business teams can use cloud services like compute, storage, network, deployment, security, intelligence, process, application, database and many others. Here we are talking about just three cloud services i.e. Compute, Network & Storage. Here in this estimation of chargeback for consumption by enterprise module, every business teams can get the access to the set of cloud services which will get the charged as per fixed and variable charges as per the usage and accordingly a chargeback report is generated.

The designer of the estimation of chargeback for consumption by enterprise module has been involved with cloud technology in a professional manner for more than a decade. He has experienced firsthand that there is a need for this module which incorporate the accountability of efficient use of cloud resources to all the heads of different business teams across any organization.

### SUMMARY

The estimation of chargeback for cloud consumption by enterprise module allows business team's heads to analyze their teams cloud's service requirements in terms of allocation and usage of those services, which has a fixed & variable charge. Here, business teams use three major services i. e. 1. Compute, 2. Storage, 3. Network. Under these three services there are many other parameters. This module prepares a detailed report for all these parameters, which is then send to the respective heads of different business teams to become more accountable with this chargeback policy in terms of cloud resources allocation, usage and expenses.

Users of this estimation of chargeback for consumption by enterprise module, cloud brain will be prompted to take the decision about detailed charge sheet. Admin generates detailed charge back report will be sent to the respective heads so that they become more accountable and uses their cloud resources team wise more efficiently & improve their productivity.

User can have variable chargeback rates for all parameters in compute, Network & storage service categories. Compute sets chargeback rates for CPU, disk I/O, fixed compute cost, memory, and network I/O items, while storage sets chargeback rates for fixed storage cost and disk storage. Chargeback costs are computed using a set formula based on hourly cost per unit and hourly usage. Chargeback rates can be assigned at a single rate or by tiers, where rates are assigned in ranges depending on level of usage per hour. Additionally, chargeback can be calculated at one fixed rate, or by a combination of fixed and variable rates per tier. Fixed rates are charged once per unit of time, and the variable rate is calculated by the level of usage multiplied by the number of resources used in a unit of time.

Network in cloud computing is interconnectivity between cloud-based application, services and solutions. Cloud network will connect a remote user with a cloud application or cloud infrastructure. User queries from a web browser/internet are delivered to and from the remote/backend cloud infrastructure. Similarly, cloud network also enables the network communication between virtual machines.

### BRIEF DESCRIPTION OF DRAWINGS

FIG. 1 is a flow of the estimation of chargeback for cloud consumption by enterprise;

FIG. 2 is a block diagram of estimation of chargeback for cloud consumption by enterprise;

FIG. 3 is a functional diagram of estimation of chargeback for cloud consumption by enterprise;

FIG. 4 is table describes organizational consolidated charge back report for a usage of cloud computing services;

FIG. 5 describes organizational consolidated charge back report for a usage of cloud Storage services;

FIG. 6 describes organizational consolidated charge back report for a usage of cloud network services;

FIG. 7 describes an example of charge back report of team A for usage of cloud compute service; and

FIG. 8 describes an example of charge back report of team A for usage of cloud storage service.

FIG. 9 describes an example of charge back report of team A for usage of cloud network service.

FIG. 10 describes an example of consolidated cloud wise chargeback report.

### DETAIL DESCRIPTION

The subject matter described in this specification related to the practice of charging the cost of IT resources usage back to the different department and business units of IT organization. Charge back makes managers aware of the cost of IT and is generally used to control escalating IT cost, improve decision making, align behavior with organizational goal and facilitate a more effective use of IT.

This method will help each team manager to use their cloud resources wisely and efficiently. By doing this wastage of cloud resources usage can be minimized.

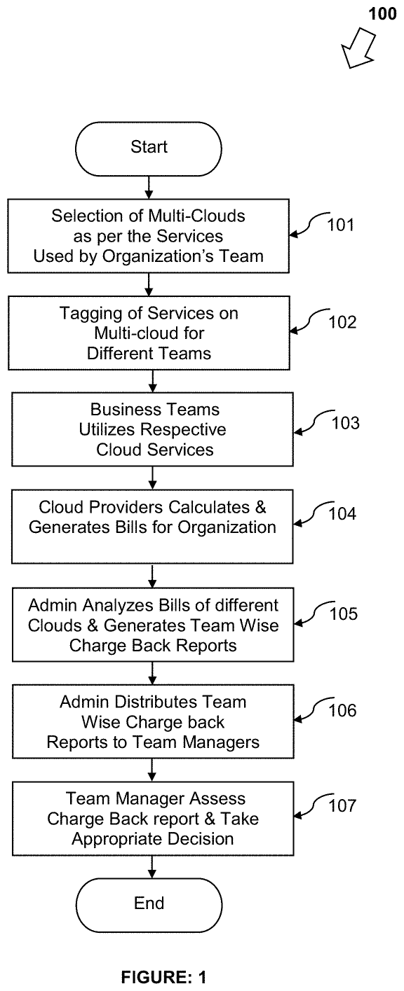

FIG. 1 is flow chart 100 of a estimation of chargeback for cloud consumption by enterprise, where different steps have been included. Initially Organization will select multiple clouds as per organization's need of cloud services 101 these services will be allotted to organizational different business teams 102, this is known as tagging of services. The selected cloud services will be used by different organizational teams 103.

Cloud provider will calculate 104 the total consumption of cloud resources used by organization. Accordingly, cloud provider will generate a bill. Each Cloud provider will generate consolidated bill.

Administrative department in organization will receive the consolidated bill of each cloud provider. Admin will analyze the bill report of different cloud provider 105 and after that he will generate team wise charge back report 105.

Admin will distribute team wise charge back reports to all team managers 106. Respective team managers will analyze the report and will take decision 107 based on report so that cloud resources will get efficiently used.

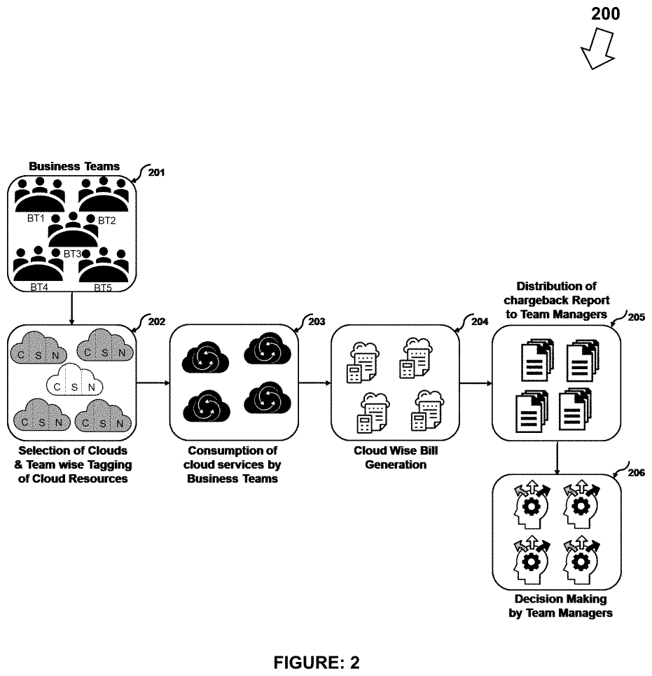

FIG. 2 is a block diagram of system 200 estimation of chargeback for consumption by enterprise. System 200 includes different business teams 201. Different business teams will select the different clouds and their cloud services 202. Team wise cloud service tagging with different cloud is done by organizational admin.

Assigned cloud services will be consumed by different organizational teams 203. As per the consumption of cloud services by different teams, cloud providers will generate the bills 204. Cloud wise bills are sent to administrative department of organization and admin of organization will analyze these bills and generate team wise charge back report 205. And all these chargeback reports will send to different team managers 205.

Team managers will analyze the chargeback report of their respective team and accordingly managers will take appropriate decision to make the system more efficient for usage of cloud resources 206.

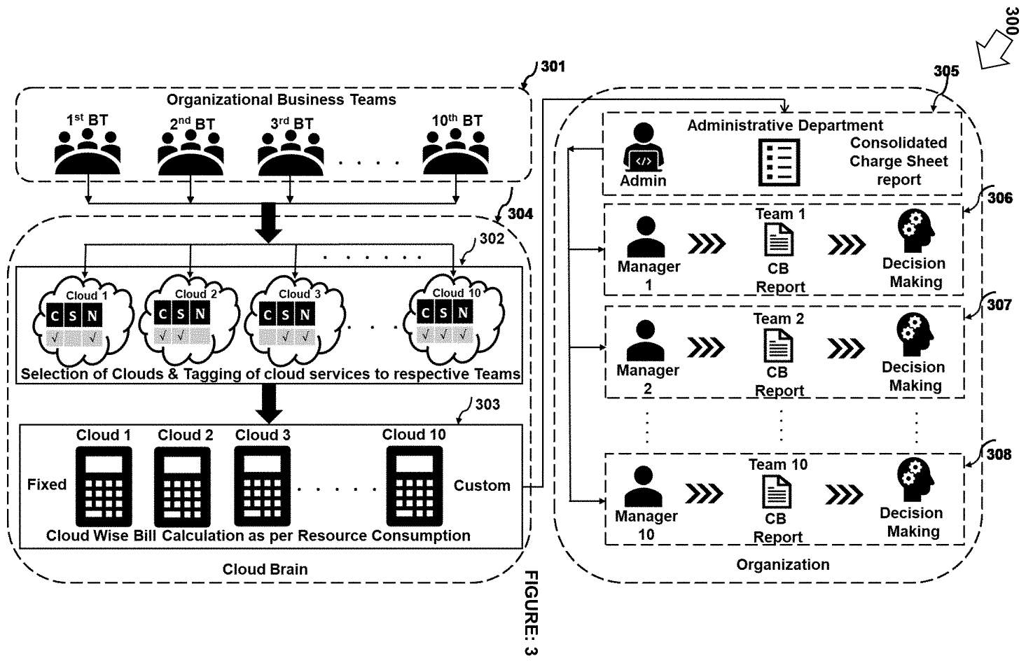

FIG. 3 is a functional diagram of estimation of chargeback for cloud consumption by enterprise 300. System 300 consists of Organization 301 consisting of 10 number of business teams, cloud brain 304 includes selection of clouds and tagging of cloud services to respective teams 302, cloud wise bill calculation as per the resources consumption 303.

Different organizational business teams 301 will select different clouds with different cloud services 302 and start utilizing cloud services like compute, storage and network. The tagging of cloud services is done by the organizational administrator.

For selected cloud services used by different teams, each cloud provider will calculate the cost as per cloud resource consumption 303. Cloud brain will receive bills according to cloud provider. This bill is calculated according to fixed and variable rates.

Administrative department 305 of organization will receive the consolidated charge sheet report or bill for each cloud analyze the bill and then admin of Administrative department will send separate charge back reports or bills to respective team managers 306, 307 and so on. Respective team managers will analyze the charge back reports and will take corrective action for efficient usage of cloud resources.

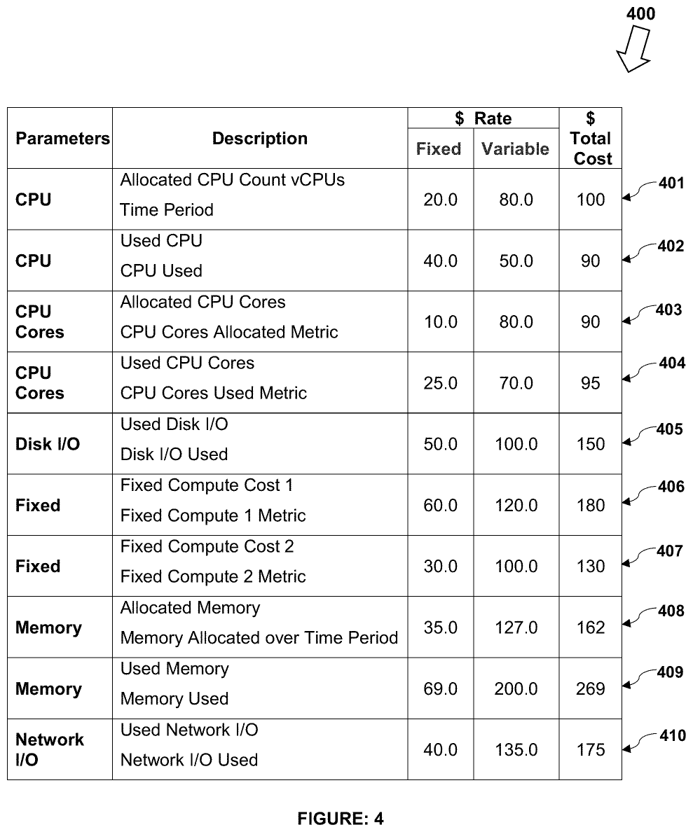

FIG. 4 is a System 400 shows the charge back report for compute service for Cloud 1. It comprises of organization's consolidated charge back report for a usage of cloud computing services. Cost has been calculated for different parameters for example allocated CPU 401, used CPU 402, allocated core CPU 403 used core CPU 404, Used disk I/O 405 fixed compute cost 406 & 407, allotted memory 408, used memory 409 and used network I/O 410. As shown in 401 allocated CPU Count vCPU time period cost for fixed rate is $20 and variable rate is $80 and the total cost allocated for this parameter is $100 for cloud 1. Similar for other parameters from 402 to 410.

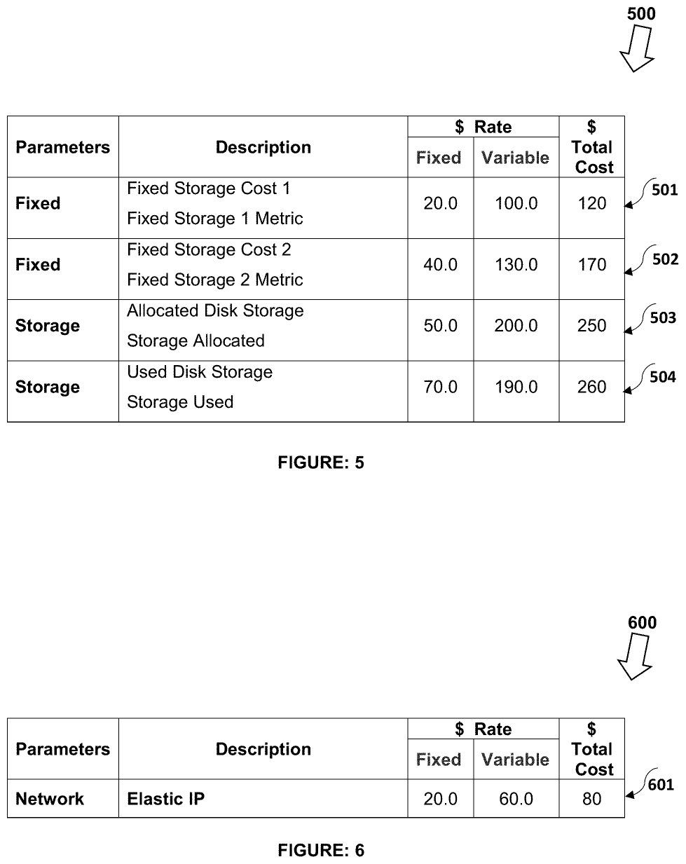

FIG. 5 is a system 500 shows generated charge back sheet of storage service consume by organization. This charge back sheet is calculated by cloud brain. It consists of organization's consolidated charge back report for the usage of cloud storage service. Cost calculation depends on different parameters like fixed storage 501 & 502, allocated disk storage 503, used disk storage 504. Total cost is calculated by adding fixed and variable cost of usage.

FIG. 6 is a table which shows generated charge back sheet of network service consumed by organization. This chargeback sheet is Calculate by cloud brain. Here EIP i.e. elastic IP is chargeable parameter in given table of 600 fixed consume cost is $20 and variable consumed network cost is $60. So, the total cost consumed by organization for network services is $80 as it is explained in 601.

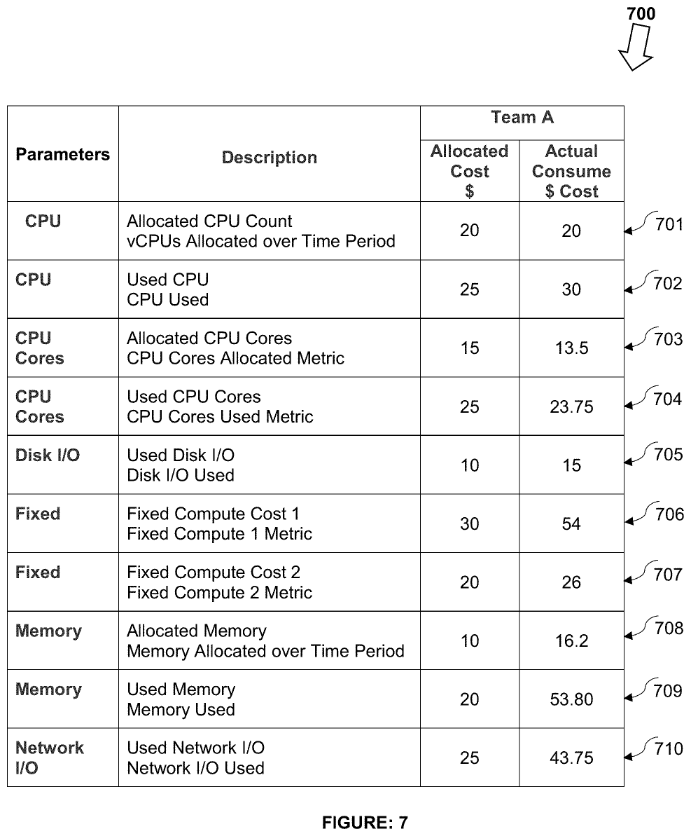

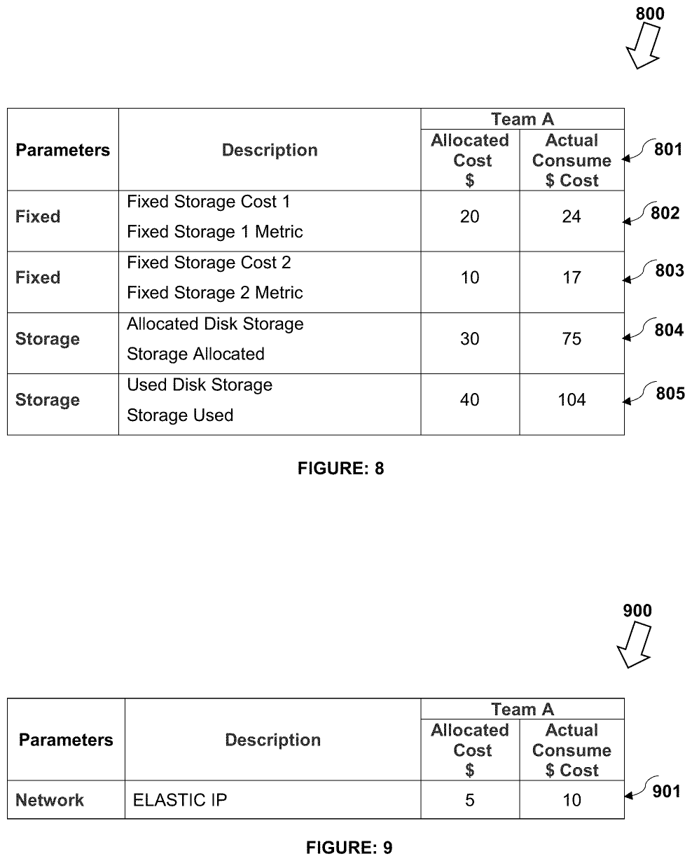

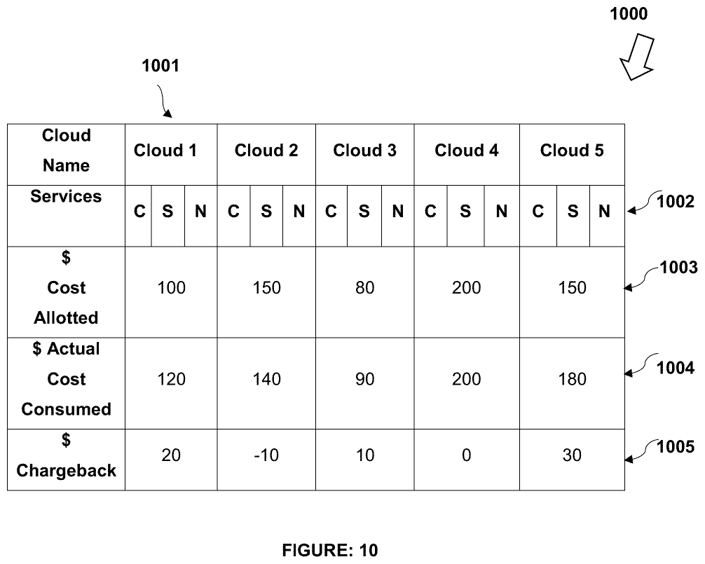

FIG. 7 is a table of charge back report for particular team manager for compute service. Example 700 explained total expenditure by team A with all compute parameters. For example, for team A allocated CPU count vCPUs allocated over time period 701 cost is $20 and the actual consume cost is $20. So, for team A has no chargeback amount. In second case 702 allocated cost for Used CPU is $25 and actual consumed cost is $30, so here for team A $5 charge back will be generated. Same we can find for other parameters for 703 to 710. Example 700 shows charge back report of compute services for team A with all parameters.

Example 800 is format of charge back report for particular team A for storage service. For the Fixed storage Cost 802 allocated cost is $20 and the actual consume cost is $24 so from this one can easily calculate charge back of $4 for this parameter. And same for the rest of parameters from 803 to 805.

Example 900 is format of charge back report for particular team say team A. as shown in 901 actual allotted cost for network service was $5 and actual consume cost by team A is $10. so, we can easily find out the charge amount back for team A which is $5.

Example 1000 is the consolidated report of all cloud which consists of allotted cost 1001 for each cloud, actual cost consumed 1004 by organization 1003 and chargeback amount 1005. Consider Cloud 1, total allotted cost was $100 and actual consumed cost consumed is $120 so extra consumed cost is $20 means chargeback amount is $20 for cloud 1. And same happens with cloud 2, 3, 4 and 5.

Configuring Chargeback for Compute Service

(A) 1. CPU Allocated Total Cost

The CPU allocated total cost is defined as the number of virtual CPUs allocated over the selected time interval which may be hour, day, week or a month. CPU allocated total costs can be measured in number of dollars per allotted CPU per hour basis. User can have different customized CPU allocated total cost in different tiers which also can vary from cloud to cloud.
Example: Assume 10 CPUs are allocated in a day with the chargeback rate set at $1 per CPU per day, the CPU allocated total cost for those 10 CPUs would be $10 for one day, similarly we can calculate for a week or a month.
10 CPUs*$1 (per CPU per day)=$10 CPU allocated Total Cost
   Chargeback rate for Business Team 1

| | | |
|---|---|---|
| Tier 1: | 0-5 Hr/CPU: | $ 6 fixed + $ 3 variable |
| Tier 2: | 6-10 Hr/CPU: | $ 4 fixed + $ 3 variable |
| Tier 3: | 11 Hr/CPU and above: | $ 3 fixed + $ 1 variable |

User can do same kind of customized charge sheet in different tiers within same and in different clouds as well & for different business teams like below.

Chargeback rate for Business Team 2

| | | |
|---|---|---|
| Tier 1: | 0-5 Hr/CPU: | $ 5 fixed + $ 3 variable |
| Tier 2: | 6-10 Hr/CPU: | $ 4 fixed + $ 2 variable |
| Tier 3: | 11 Hr/CPU and above: | $ 2 fixed + $ 1 variable |

In the same fashion user can create such customized charge sheet for all other business units.

2. CPU Used Cost

The CPU used cost is defined as the average CPU used in a given allotted bandwidth which is measured in Hz over the selected time interval like per hour, per day, per week or per month. CPU used cost for an hour is defined as the number of dollars per MHz per hour. User can have different customized CPU used cost in different tiers which also can vary from cloud to cloud.
Example: Assume 2 GHz is used in a day with the chargeback rate set at $0.01 per MHz per day, the CPU Used Cost would be $25.
2.5 GHz=2500 MHz
2500 MHz*$0.01 (per MHz per day)=$25 CPU Used Cost
   Chargeback rate for Business Team 1

| | | |
|---|---|---|
| Tier 1: | 0-5 Hr/CPU: | $ 6 fixed + $ 3 variable |
| Tier 2: | 6-10 Hr/CPU: | $ 4 fixed + $ 3 variable |
| Tier 3: | 11 Hr/CPU and above: | $ 3 fixed + $ 1 variable |

User can do same kind of customized charge sheet in different tiers within same and in different clouds as well & for different business teams like this.
Chargeback rate for Business Team 2

| | | |
|---|---|---|
| Tier 1: | 0-5 Hr/CPU: | $ 5 fixed + $ 3 variable |
| Tier 2: | 6-10 Hr/CPU: | $ 4 fixed + $ 2 variable |
| Tier 3: | 11 Hr/CPU and above: | $ 2 fixed + $ 1 variable |

In the same fashion user can create such customized charge sheet for all other business units.

(B) 1. CPU Core Allocated Total Cost

The CPU core allocated total cost is defined as the number of processor allocated over the selected time interval which may be hour, day, week or a month. CPU core allocated total costs can be measured in number of dollars per CPU core (processor) per hour basis as per separately specified for all different clouds when assigning a chargeback rate. User can have different customized CPU core allocated total cost in different tiers which also can vary from cloud to cloud.
Example: One, two, four, six, eight, eighteen cores can be there. Like octa core processor has 8 cores, therefore if 8 CPU cores used in a day with the chargeback rate set at $1 per CPU per day, then CPU core allocated Total Cost would be $8.
8 CPUs*$1 (per CPU core per day)=$8 CPU core Total Cost
   Chargeback rate for Business Team 1

| | | |
|---|---|---|
| Tier 1: | 0-5 Hr/CPU core: | $ 6 fixed + $ 3 variable |
| Tier 2: | 6-10 Hr/CPU core: | $ 4 fixed + $ 2 variable |
| Tier 3: | 11 Hr/CPU core and above: | $ 2 fixed + $ 1 variable |

User can do same kind of customized charge sheet in different tiers within same and in different clouds as well & for different business teams like this.
Chargeback rate for Business Team 2

| | | |
|---|---|---|
| Tier 1: | 0-5 Hr/CPU core: | $ 5 fixed + $ 3 variable |
| Tier 2: | 6-10 Hr/CPU core: | $ 4 fixed + $ 3 variable |
| Tier 3: | 11 Hr/CPU core and above: | $ 3 fixed + $ 1 variable |

In the same fashion user can create such customized charge sheet for all other business units.

2. CPU Core Used Cost

The CPU core used Cost is defined as the number of processors used over the selected time interval which may be hour, day, week or a month. CPU core used cost can be measured in number of dollars per CPU core (processor) used per hour basis as per separately specified for all different clouds when assigning a chargeback rate. User can have different customized CPU core used cost in different tiers which also can vary from cloud to cloud.
Example: One, two, four, six, eight, eighteen cores can be there. Like quad core processor has 4 cores, therefore if 8 CPU cores used in a day with the chargeback rate set at 1 dollar per CPU per day, then CPU core used cost would be $4.
4 CPUs*$1 (per CPU core per day)=$4 CPU core Total Cost
   Chargeback rate for Business Team 1

| | | |
|---|---|---|
| Tier 1: | 0-5 Hr/CPU core: | $ 6 fixed + $ 3 variable |
| Tier 2: | 6-10 Hr/CPU core: | $ 4 fixed + $ 2 variable |
| Tier 3: | 11 Hr/CPU core and above: | $ 2 fixed + $ 1 variable |

User can do same kind of customized charge sheet in different tiers within same and in different clouds as well & for different business teams like this.
Chargeback rate for Business Team 2

| | | |
|---|---|---|
| Tier 1: | 0-5 Hr/CPU core: | $ 5 fixed + $ 3 variable |
| Tier 2: | 6-10 Hr/CPU core: | $ 4 fixed + $ 2 variable |
| Tier 3: | 11 Hr/CPU core and above: | $ 2 fixed + $ 1 variable |

In the same fashion user can create such customized charge sheet for all other business units.

(C) 1. Used Disk I/O Cost

The speed with which the data transfer Input/output operations takes place between the hard disk drive and RAM and it is defined in Kbps. The used disk I/O cost is defined as number of dollars per kbps per hour for both operations. User can have different customized used disk I/O cost in different tiers which also can vary from cloud to cloud.
Example. Assume for 500 Kbps with the chargeback rate is $0.1 per kbps per hour, then the used disk I/O cost for a day can be $12.
Chargeback rate for Business Team 1:

| | | |
|---|---|---|
| Tier 1: | 0-5 Hr/kbps: | $ 6 fixed + $ 3 variable |
| Tier 2: | 6-10 Hr/kbps: | $ 4 fixed + $ 2 variable |
| Tier 3: | 11 Hr/kbps and above: | $ 2 fixed + $ 1 variable |

User can do same kind of customized charge sheet in different tiers within same and in different clouds as well & for different business teams like this.
Chargeback rate for Business Team 2

| | | |
|---|---|---|
| Tier 1: | 0-5 Hr/kbps: | $ 5 fixed + $ 3 variable |
| Tier 2: | 6-10 Hr/kbps: | $ 4 fixed + $ 2 variable |
| Tier 3: | 11 Hr/kbps and above: | $ 2 fixed + $ 1 variable |

In the same fashion user can create such customized charge sheet for all other business units

2. Fixed Compute Cost

Fixed compute cost is a fixed hourly billing of machine in dollars per hour. User can have different customized fixed compute cost in different tiers which also can vary from cloud to cloud.
Example. If 5 machines are computing with chargeback rate of $1 per machine per hour, then fixed compute cost for all 5 machines for 1 hour would be $5.
Chargeback rate for Business Team 1

| | | |
|---|---|---|
| Tier 1: | 0-5 Hr/CPU: | $ 6 fixed + $ 3 variable |
| Tier 2: | 6-10 Hr/CPU: | $ 4 fixed + $ 2 variable |
| Tier 3: | 11 Hr/CPU and above: | $ 2 fixed + $ 1 variable |

User can do same kind of customized charge sheet in different tiers within same and in different clouds as well & for different business teams like this.

Chargeback rate for Business Team 2

| | | |
|---|---|---|
| Tier 1: | 0-5 Hr/CPU: | $ 5 fixed + $ 3 variable |
| Tier 2: | 6-10 Hr/CPU: | $ 4 fixed + $ 2 variable |
| Tier 3: | 11 Hr/CPU and above: | $ 2 fixed + $ 1 variable |

In the same fashion user can create such customized charge sheet for all other business units.

(D) Allocated Memory Cost & Used Memory Cost

Allocated Memory cost is a memory allocation in MB per hour & Used Memory is used memory in MB per hour and their costs are in numbers of dollars per MB per hour. User can have different customized allocated memory cost & used memory cost in different tiers which also can vary from cloud to cloud.
Example: Allocated memory cost & Memory Used Cost
Assume 5 GB of memory is used in a day with the chargeback rate set at dollar ($0.01) per megabyte per day, the Memory Used Cost would be $396.42.
5 GB=5000 MB
5000 MB*$0.01 (per MB per day)=$50
$50/24=$2.083 Memory Used Cost/hour
   Chargeback rate for Business Team 1

| | | |
|---|---|---|
| Tier 1: | 0-5 Hr/MB: | $ 6 fixed + $ 3 variable |
| Tier 2: | 6-10 Hr/MB: | $ 4 fixed + $ 2 variable |
| Tier 3: | 11 Hr/MB and above: | $ 2 fixed + $ 1 variable |

User can do same kind of customized charge sheet in different tiers within same and in different clouds as well & for different business teams like this.
Chargeback rate for Business Team 2

| | | |
|---|---|---|
| Tier 1: | 0-5 Hr/MB: | $ 5 fixed + $ 3 variable |
| Tier 2: | 6-10 Hr/MB: | $ 4 fixed + $ 2 variable |
| Tier 3: | 11 Hr/MB and above: | $ 2 fixed + $ 1 variable |

In the same fashion user can create such customized charge sheet for all other business units.

(E) Network I/O Cost

The speed with which the network data upload and download operations takes place between cloud and machine and it is defined in Kbps. The used network I/O cost is defined as number of dollars per kbps per hour for both operations. User can have different customized network I/O cost in different tiers which also can vary from cloud to cloud.
Example. Assume for 500 Kbps with the chargeback rate is $0.1 per kbps per hour, then the used network I/O cost for a day can be $12.
Chargeback rate for Business Team 1:

| | | |
|---|---|---|
| Tier 1: | 0-5 Hr/kbps: | $ 6 fixed + $ 3 variable |
| Tier 2: | 6-10 Hr/kbps: | $ 4 fixed + $ 2 variable |
| Tier 3: | 11 Hr/kbps and above: | $ 2 fixed + $ 1 variable |

User can do same kind of customized charge sheet in different tiers within same and in different clouds as well & for different business teams like this.
Chargeback rate for Business Team 2

| | | |
|---|---|---|
| Tier 1: | 0-5 Hr/kbps: | $ 5 fixed + $ 3 variable |
| Tier 2: | 6-10 Hr/kbps: | $ 4 fixed + $ 2 variable |
| Tier 3: | 11 Hr/kbps and above: | $ 2 fixed + $ 1 variable |

In the same fashion user can create such customized charge sheet for all other business units

Configuring Chargeback for Storage Service.

(A) 1. Fixed Storage Cost

Fixed storage cost is a cloud computing model in which data is stored, maintained, operated and managed on remote servers accessed from the internet. Fixed storage cost is given as number of dollars per MB per hour. User can have different customized fixed storage cost in different tiers which also can vary from cloud to cloud.
Example. Assume $1 for 1 GB storage per hour. So, for a day fixed storage cost will be $24 for 24 GB in a day.
Chargeback rate for Business Team 1

| | | |
|---|---|---|
| Tier 1: | 0-5 Hr/MB: | $ 6 fixed + $ 3 variable |
| Tier 2: | 6-10 Hr/MB: | $ 4 fixed + $ 2 variable |
| Tier 3: | 11 Hr/MB and above: | $ 2 fixed + $ 1 variable |

User can do same kind of customized charge sheet in different tiers within same and in different clouds as well & for different business teams like this.
Chargeback rate for Business Team 2

| | | |
|---|---|---|
| Tier 1: | 0-5 Hr/MB: | $ 5 fixed + $ 3 variable |
| Tier 2: | 6-10 Hr/MB: | $ 4 fixed + $ 2 variable |
| Tier 3: | 11 Hr/MB and above: | $ 2 fixed + $ 1 variable |

In the same fashion user can create such customized charge sheet for all other business units.

2. Allocated Disk Storage Cost

The allocated disk Storage Cost is defined as the Allocated Disk Storage in bytes over the selected time interval may be per hour, per day, per week, or per month. User can have different customized allocated disk storage cost in different tiers which also can vary from cloud to cloud.
Example: Assume 200 GB are used in a day with the chargeback rate set at $0.10 per GB per day, the Allocated disk storage Cost would be $20.
2147483648 bytes=200 GB
200 GB*$0.10 (per GB per day)=$20 Allocated disk storage Cost
   Chargeback rate for Business Team 1

| | | |
|---|---|---|
| Tier 1: | 0-5 Hr/MB: | $ 6 fixed + $ 3 variable |
| Tier 2: | 6-10 Hr/MB: | $ 4 fixed + $ 2 variable |
| Tier 3: | 11 Hr/MB and above: | $ 2 fixed + $ 1 variable |

User can do same kind of customized charge sheet in different tiers within same and in different clouds as well & for different business teams like this.
Chargeback rate for Business Team 2

| | | |
|---|---|---|
| Tier 1: | 0-5 Hr/MB: | $ 5 fixed + $ 3 variable |
| Tier 2: | 6-10 Hr/MB: | $ 4 fixed + $ 2 variable |
| Tier 3: | 11 Hr/MB and above: | $ 2 fixed + $ 1 variable |

In the same fashion user can create such customized charge sheet for all other business units.

(B) Storage Total Cost

The Storage Total Cost is defined as the Used Disk Storage in bytes over the selected time interval may be per hour, per day, per week, or per month. User can have different customized storage total cost in different tiers which also can vary from cloud to cloud.
Example: Assume 250 GB are used in a day with the chargeback rate set at $0.10 per GB per day, the Storage Total Cost would be $25.
268,435,456,000 bytes=250 GB
250 GB*$0.10 (per GB per day)=$25 Storage Total Cost
   Chargeback rate for Business Team 1

| | | |
|---|---|---|
| Tier 1: | 0-5 Hr/MB: | $ 6 fixed + $ 3 variable |
| Tier 2: | 6-10 Hr/MB: | $ 4 fixed + $ 2 variable |
| Tier 3: | 11 Hr/MB and above: | $ 2 fixed + $ 1 variable |

User can do same kind of customized charge sheet in different tiers within same and in different clouds as well & for different business teams like this.
Chargeback rate for Business Team 2

| | | |
|---|---|---|
| Tier 1: | 0-5 Hr/MB: | $ 5 fixed + $ 3 variable |
| Tier 2: | 6-10 Hr/MB: | $ 4 fixed + $ 2 variable |
| Tier 3: | 11 Hr/MB and above: | $ 2 fixed + $ 1 variable |

In the same fashion user can create such customized charge sheet for all other business units.

After customized charge sheet with different tiers, for different business teams cloud brain triggers the customized billing chargeback report to the respective given business teams heads. After analysis of chargeback report of each team, managers become more accountable to take appropriate decision for team and about monitoring, resource allocation and consumption should be more efficiently & improve their productivity.

(C) Network

Network is one of the most important parameters in cloud computing. Network selection gives connectivity between two parties is establishes and speed of data transfer. Data transfer will be fast if we select more frequency and vice versa.

What is claimed as:

1. A method for estimation of chargeback for cloud consumption by enterprise comprising;
Selection of cloud services by an organization; Tagging of cloud services used by business units;
Charge sheet calculation for multi-cloud as per the resource usage;
Charge back report generation;
As per the charge back report managers do analysis and take decision for efficient use of cloud resources.

2. The method of claim 1;
Further, providing a different cloud services of multi-cloud, here we have used storage, network and compute services by business teams in organization.

3. Cloud brain will calculate cost of cloud resources consumed by business teams and will generate separate different Sheets.

4. The consolidated charge sheets will be analyzed by organizational administrator and he will generate team wise chargeback reports. By analyzing this charge back reports, managers of each team will be able to take appropriate decision for efficient use of cloud resources.

5. This module will give the information to analyze to mangers how much amount of cloud resources have been used by different teams. And accordingly, they can charge back to teams.
